(19) United States
(12) Patent Application Publication
(10) Pub. No.: US 2007/0039821 A1
(43) Pub. Date: Feb. 22, 2007

(54) Electrochemical sensor

(76) Inventor: Robert Bruce Grant, Steyning (GB)

Correspondence Address: THE BOC GROUP, INC., 575 MOUNTAIN AVENUE, MURRAY HILL, NJ, 07974-2064, US

(21) Appl. No.: 10/574,640

(22) PCT Filed: Sep. 23, 2004
(86) PCT No.: PCT/GB04/04122

§ 371 Date: Mar. 31, 2006

(30) Foreign Application Priority Data
Oct. 7, 2003 (GB) 0323417.6

(51) Int. Cl. G01N 27/26

(52) U.S. Cl. 204/426

(57) ABSTRACT

An organic contaminant molecule sensor is described for use in a low oxygen concentration monitored environment. The sensor comprises an electrochemical call comprising a solid state oxygen anion conductor (14) in which oxygen anion conduction occurs at or above a critical temperature T_{c}, an active measurement electrode (10) formed on a first surface (12) of the conductor for exposure to the monitored environment, the measurement electrode comprising material for catalysing the oxidation of an organic contaminant molecule to carbon dioxide and water, an inert measurement electrode (18), formed on the first surface (12) of the conductor adjacent to and independent from the active measurement electrode, for exposure to the monitored environment, the inert measurement electrode comprising material that is catalytically inert to the oxidation of an organic contaminant molecule, and a reference electrode (20) formed on a second surface (22) of the conductor for exposure to a reference environment, the reference electrode comprising material for catalysing the dissociative adsorption of oxygen. Means (30, 32) are provided for controlling and monitoring the temperature of the cell. Means (34) are also provided for controlling the electrical current Iₐ flowing between the reference electrode and the active measurement electrode and the electrical current Iᵢ flowing between the reference electrode and the inert measurement electrode, thereby to control the flux of oxygen anions flowing between the reference electrode and the active and inert measurement electrodes respectively. The potential difference between the active measurement electrode and the inert electrode is monitored (36), whereby in the absence of organic contaminant molecules the potential difference Vₛₑₙₛₑ between the active and inert measurement electrodes assumes a base value V_{b} and in the presence of organic contaminant molecules the potential difference Vₛₑₙₛₑ between the active and inert measurement electrodes assumes a measurement value Vₘ, the value Vₘ-V_{b} being indicative of the concentration of organic contaminant molecules present in the monitored environment.

This invention relates to a sensor for the detection of organic contaminants in low oxygen concentration process environments, such as those used in the semiconductor manufacturing industry, the use of such sensors and a novel method for the detection of organic contaminants in such process environments. The term “low oxygen concentration process environment” is to be understood to mean a process environment in which the partial pressure of oxygen is of the order of 10⁻⁶ mbar to 10⁻³ mbar (parts per billion to parts per million).

In, for example, the semiconductor manufacturing industry, it is important to control the atmosphere (the process environment) in which wafers are manufactured. The wafers are desirably manufactured in a controlled environment, as undesirable or varying levels of organic contaminants can result in device and/or equipment failure.

Levels of contaminating organic material in the parts per trillion (ppt) to parts per billion (ppb) range, which corresponds to a partial pressure of 10⁻⁹ mbar to 10⁻⁶ mbar, do not, in general, result in device or equipment failure. However, if the levels of organic contaminants become much higher than this, failures may result. In order to control the process environment, it is necessary to monitor the levels of organic contaminants present. In particular, some processes are sensitive to contaminant material in the low ppb range, and so for these processes it is desirable to monitor the level of contaminant materials in the ppt range. However, such monitoring processes are costly and it is difficult to determine an accurate value for the total organic compounds (TOC) present at such low contaminant levels. In addition, many fabrication processes are tolerant of light saturated hydrocarbons, such as methane (CH₄) and ethane (C₂H₆), which have particularly low reaction probabilities with most surfaces and therefore do not take part in the various contamination inducing reactions.

In vacuum based process environments, TOC levels are often determined using mass spectrometry, as a mass spectrometer is capable of measuring contamination levels of the order of ppt. However the interpretation of such measurements is often complicated by effects such as mass spectral overlap, molecular fragmentation and background effects, for example.

Although mass spectrometers can be used in process environments operating at ambient pressure or above, additional vacuum and sample handling systems are required, which make such instruments very expensive. Under such conditions, it is preferred to use gas chromatographic techniques to monitor the TOC levels present in the process environment. However, in order to monitor contaminants in the ppt range it is necessary to fit the gas chromatogram with a gas concentrator.

It should be noted that although mass spectrometry and gas chromatography are able to detect ppt levels of TOC, their ability to differentiate the presence of the process-tolerant light hydrocarbons referred to above from the more harmful organic compounds is limited, which makes it difficult to determine the total levels of damaging hydrocarbons in the process environment.

In addition, because the use of either mass spectrometric or gas chromatographic techniques for determining the TOC levels present in process environments requires specialist equipment, they tend to be rather expensive and are typically only used as Point of Entry (POE) monitors for the whole facility rather than the more useful Point of Use (POU) monitors.

Hydrocarbons, including light hydrocarbons such as methane (CH₄) and ethane (C₂H₆), have been routinely monitored using common tin oxide (SnO₂) based sensor devices. These sensors typically operate under atmospheric pressure to detect target gases in the range from tens of ppb (parts per billion) to several thousand ppm (parts per million). This type of sensor works effectively within these ranges by providing a linear output signal that is directly proportional to the quantity of target gas within the monitored environment. Although these sensors are suitable for monitoring contaminant levels within ambient environments, they do not lend themselves for applications with sub-atmospheric processing environments such as those encountered within semiconductor processing environments. Under such vacuum conditions the SnO₂-type of sensor will suffer from reduction of the active oxide content leading to signal drift and non-response after a period of time.

Chemical sensors comprising solid state electrolytes such as oxygen anion conductors, or silver or hydrogen cation conductors, have been used to monitor levels of oxygen, carbon dioxide, and hydrogen/carbon monoxide gas present in a process environment and are described in United Kingdom patent application number 0308939.8 and GB 2,348,006A, GB 2,119,933A respectively. Such sensors are generally formed from an electrochemical cell comprising a measurement electrode, a reference electrode and a solid state electrolyte of a suitable ionic conductor disposed between and bridging said electrodes.

For example, the gas monitor of GB 2,348.006A comprises a detection electrode containing a silver salt having an anion, which corresponds to the gas to be detected, a silver ion conducting solid state electrolyte and a reference silver electrode. The gas monitor can be used to detect gases such as carbon dioxide, sulphur dioxide, sulphur trioxide, nitrogen oxides and halogens through the suitable choice of the appropriate anion.

For the oxygen sensors of United Kingdom patent application number 0308939.8, the solid state electrolyte conducts oxygen anions and the reference electrode is generally coated or formed from a catalyst that is able to catalyse the dissociative adsorption of oxygen and is positioned within a reference environment, in which the concentration of oxygen adjacent the reference electrode remains constant.

Solid state oxygen anion conductors (solid state electrolytes) are generally formed from doped metal oxides such as gadolinium doped ceria or yttria stabilised zirconia (YSZ). At temperatures below the critical temperature for each electrolyte (T_{c}) the electrolyte material is non-conducting. At temperatures above T_{c} the electrolyte becomes progressively more conductive.

Oxygen levels as determined by such sensors in any monitored environment is determined by the electrochemical potentials generated by the reduction of oxygen gas at both the measurement and reference electrodes. The steps associated with the overall reduction reactions at each electrode are set out below, the half-cell reaction at each electrode being defined by equations 1 and 2 below.

$$\begin{matrix}{O}_{2 ( gas )} ⇆ 2 {O}_{( ads )} & Equation 1 \\ {O}_{( ads )} + 2 {e}^{-} ⇆ {O}^{2 -} & Equation 2\end{matrix}$$

The electrochemical potential generated at each electrode is determined by the Nernst equation:

$$E = {E}^{Θ} + \frac{RT}{2 F} ln \frac{a ( {O}_{ads} )}{a ( {O}^{2 -} )} \qquad Equation 3$$

where

E is the electrochemical half-cell potential at the reference or measurement electrode respectively;

E^{Θ} is the standard electrochemical half cell potential of the cell at unit O(_{ads}) activity

R is the gas constant

T is the temperature of the cell

F is Faraday's constant

a(O_{ads}) and a(O²⁻) are the activities of the adsorbed oxygen at the electrode surface and reduced oxygen anion in the solid state ionic conductor respectively.

The activity of adsorbed oxygen at the electrode surface is directly proportional to the partial pressure of oxygen gas, P_{O2}, in the environment adjacent the electrode as defined by equation 4 below:

$$a ( {O}_{ads} ) = {KP}_{{O}_{2}}^{1 / 2} \qquad Equation 4$$

Since a(O²⁻) is unity, by definition, and the activity of the adsorbed oxygen at the electrode surface is proportional to the partial pressure of the oxygen in the environment adjacent the electrode surface (equation 4), the half cell potential can be written in terms of the partial pressure of oxygen in the particular environment adjacent the measurement or reference electrode respectively

$$E = {E}^{Θ} + \frac{RT}{4 F} ln {P}_{{O}_{2}} \qquad Equation 5$$

The potential difference V generated across the cell is defined in terms of the difference in the half-cell potentials between the reference and measurement electrodes in accordance with equation 6.

$$V = {E}_{( R )} - {E}_{( M )} = \frac{RT}{4 F} Ln ( \frac{{P}_{O 2 ( R )}}{{P}_{O 2 ( M )}} ) \qquad Equation 6$$

where

V is the potential difference across the cell

E_{(R)} and E_{(M)} are the electrochemical potentials at the reference and measurement electrodes respectively;

R, T and F are as defined above; and

P_{O2(R)} and P_{O2(M)} are the partial pressures of oxygen at the reference and measurement electrodes respectively.

Note that if both the reference and measurement electrodes are exposed to the same oxygen partial pressure e.g. atmospheric levels of oxygen, the potential difference across the cell is zero. In process environments such as the oxygen deficient environments encountered in the manufacture of semiconductor products the partial pressure of oxygen adjacent the measurement electrode is considerably less than that adjacent the reference electrode. Since the electrochemical potential at each electrode is governed by the Nemst equation, as the partial pressure of oxygen at the measurement electrode decreases, the electrochemical potential at the measurement electrode changes, which results in the formation of a potential difference across the cell at temperatures above the critical temperature. The potential difference across the cell is determined by the ratio of the partial pressure of oxygen at the reference and measurement electrodes in accordance with equation 6 above. The oxygen sensor can therefore provide a user with an indication of the total amount of oxygen present in a monitored environment simply from determining the potential difference across the cell.

Reducing gases such as hydrogen, carbon monoxide, nitrous oxides and hydrocarbons present in oxygen rich environments (% levels of oxygen) such as automobile exhaust gases, for example, can be detected using mixed potential sensors. Such sensors comprise a solid state oxygen anion conductor electrolyte having dissimilar catalytic electrodes formed on one surface thereof. The sensor response results from the development of an equilibrium mixed potential difference between the catalytically dissimilar electrodes in the presence of the reducing gas as outlined for example in DE95/00255 where the dissimilar catalytic reactions are enhanced by operating the electrodes at different temperatures. The mixed potential for a particular electrode surface arises from the competition between the electrochemical reduction of oxygen (equation 7) and the oxidation or combustion of the organic/reducing material arriving at the electrode surface (e.g. for carbon monoxide equation 8).

$$\begin{matrix}{O}_{2} + 2 {V}_{o} + 4 {e}^{-} ⇆ 2 {O}_{o} & Equation 7 \\ CO + {O}_{o} ⇆ {CO}_{2} + {V}_{o} + 2 {e}^{-} & Equation 8\end{matrix}$$

where Vₒ is a doubly charged oxygen anion vacancy and Oₒ is a filled oxygen anion site in the oxygen anion conducting solid state electrolyte.

Since the carbon monoxide, for example, is oxidised at the surface of one of the electrodes only (namely the catalytically active electrode), adsorbed oxygen is consumed at that electrode and the electrochemical potential at the active electrode increases as a result. The other electrode is catalytically inactive and oxidation of the carbon monoxide does not occur here. This means that the concentration of adsorbed oxygen at the surface of this electrode remains constant and is independent of the carbon monoxide partial pressure. This is reflected by the measured electrochemical potential at that electrode. The difference in electrochemical potentials between the active and inert electrodes is a reflection of the difference in equilibrium amounts of adsorbed oxygen present at the surface of the electrodes. The amount of carbon monoxide in the atmosphere can therefore be determined from the equilibrium potential voltage. These mixed potential sensors provide a good indication of the concentration of reducing gases present in the monitored environment if the environment is rich in oxygen (% levels of oxygen). However, they are unsuitable for use in environments containing little or no oxygen.

There is therefore a need for a similar simple, low cost, semi-quantitative sensor, which has a low sensitivity to unreactive organic compounds but can be used at the point of use to analyse oxygen deficient process environments. In at least its preferred embodiment, the present invention seeks to address that need.

A first aspect of the present invention provides an organic contaminant molecule sensor for use in a low oxygen concentration monitored environment, the sensor comprising an electrochemical cell comprising a solid state oxygen anion conductor in which oxygen anion conduction occurs at or above a critical temperature T_{c}, an active measurement electrode formed on a first surface of the conductor for exposure to the monitored environment, the measurement electrode comprising material for catalysing the oxidation of an organic contaminant molecule to carbon dioxide and water, an inert measurement electrode, formed on the first surface of the conductor adjacent to and independent from the active measurement electrode, for exposure to the monitored environment, the inert measurement electrode comprising material that is catalytically inert to the oxidation of an organic contaminant molecule, and a reference electrode formed on a second surface of the conductor for exposure to a reference environment, the reference electrode comprising material for catalysing the dissociative adsorption of oxygen; means for controlling and monitoring the temperature of the cell; means for controlling the electrical current Iₐ flowing between the reference electrode and the active measurement electrode and the electrical current Iᵢ flowing between the reference electrode and the inert measurement electrode, thereby to control the flux of oxygen anions flowing between the reference electrode and the active and inert measurement electrodes respectively; and means for monitoring the potential difference between the active measurement electrode and the inert electrode, whereby in the absence of organic contaminant molecules the potential difference Vₛₑₙₛₑ between the active and inert measurement electrodes assumes a base value V_{b} and in the presence of organic contaminant molecules the potential difference Vₛₑₙₛₑ between the active and inert measurement electrodes assumes a measurement value Vₘ, the value Vₘ-V_{b} being indicative of the concentration of organic contaminant molecules present in the monitored environment.

A second aspect of the present invention provides an organic contaminant molecule sensor for use in a low oxygen concentration monitored environment, the sensor comprising an electrochemical cell comprising an oxygen anion conductor in which oxygen anion conduction occurs at or above a critical temperature T_{c}, an active measurement electrode in contact with the conductor for exposure to the monitored environment, the measurement electrode comprising material for catalysing the oxidation of an organic contaminant molecule to carbon dioxide and water, an inert measurement electrode, in contact with the conductor independent from the active measurement electrode, for exposure to the monitored environment, the inert measurement electrode comprising material that is catalytically inert to the oxidation of an organic contaminant molecule, and a reference electrode in contact with the conductor for exposure to a reference environment, the reference electrode comprising material for catalysing the dissociative adsorption of oxygen; means for controlling and monitoring the temperature of the cell; means for controlling the electrical current Iₐ flowing between the reference electrode and the active measurement electrode and the electrical current Iᵢ flowing between the reference electrode and the inert measurement electrode, thereby to control the flux of oxygen anions flowing between the reference electrode and the active and inert measurement electrodes respectively such that the NEMCA effect is activated; and means for monitoring the potential difference between the active measurement electrode and the inert electrode, whereby in the absence of organic contaminant molecules the potential difference Vₛₑₙₛₑ between the active and inert measurement electrodes assumes a base value V_{b} and in the presence of organic contaminant molecules the potential difference Vₛₑₙₛₑ between the active and inert measurement electrodes assumes a measurement value Vₘ, the value Vₘ-V_{b} being indicative of the concentration of organic contaminant molecules present in the monitored environment.

In the absence of organic contaminants, the potential difference between the active and inert measurement electrodes is constant and is determined by the differences in the catalytic rate of recombination and desorption of oxygen from the surfaces of the active and inert measurement electrodes respectively as influenced by the currents Iₐ and Iᵢ flowing between the reference electrode and the active and inert measurement electrodes respectively. However, when organic contaminants are introduced into the process environment, they are catalytically oxidised at the surface of the active measurement electrode and the concentration of adsorbed oxygen at the surface of the active measurement electrode decreases. This means that, in accordance with equation 3 above, the potential difference, Vₛₑₙₛₑ, between the active and inert measurement electrodes increases to a value Vₘ. By suitably calibrating the monitor, the difference Vₘ-V_{b} between the potential differences in the presence and absence of organic contaminant molecules can be used to determine the concentration of organic contaminant molecules in the process environment.

It should be noted that the provision of means for controlling the electrical currents, Iₐ and Iᵢ, flowing between the reference electrode and the active and inert measurement electrodes respectively, thereby to control the flux of oxygen anions flowing between the reference electrode and the active and inert measurement electrodes respectively, allows the sensor to determine low levels of organic contaminant in low oxygen concentration environments. The provision of currents Iₐ and Iᵢ provides a source of oxygen at the surface of each of the electrodes. The provision of such an oxygen source is particularly important at the surface of the active measurement electrode since it provides a source of oxygen for reaction with the organic contaminant at the surface of that electrode. This is important since it means that the response of the sensor does not rely on the presence of oxygen gas in the sensing atmosphere itself. The sensor can therefore be used to provide a semi-quantitative indication of the presence of organic material by measuring a parameter which depends upon the difference in the catalytic rates of oxidation occurring between the active and inert measurement electrodes—usually the potential difference between the active and inert electrodes relative to the reference electrode.

In use the sensor operates by passing a small anion current, Iₐ (O²⁻), between the reference electrode and one of the measurement electrodes to maintain the potential difference between that measurement and reference electrodes at a fixed value, Vₐ. Depending upon the electrode configuration, three possible sensing modes are possible:

Firstly the active and inert measurement electrodes may be formed from catalytically dissimilar materials. The active electrode may, for example, be formed from platinum and the inert electrode from gold. In use the current, Iᵢ, flowing between the reference electrode and inert measurement electrode mirrors that between the reference and active measurement electrode, Iₐ, and the potential difference between the two sensing electrodes is measured.

Secondly the current Iᵢ may be a sub-unit multiple of or equal to the current, Iₐ, flowing between the reference electrode and the active measurement electrode and the potential difference between the two sensing electrodes is again measured.

Finally, the active and inert measurement electrodes may be formed from catalytically similar materials, such as platinum, for example. In this case the current flowing between the reference and inert sensing electrodes is a sub-unit multiple of the current, Iₐ, flowing between the reference and active measurement electrodes and the potential difference between the two sensing electrodes is again measured.

In all cases the potential difference between the active and inert measurement electrodes will depend upon the positions of the mixed potential present on the electrode surface. The mixed potential, for a particular electrode surface, arises from the catalytic competition between the electrochemical reduction of oxygen and the oxidation or combustion of the organic material arriving at the electrode surface.

$$\begin{matrix}{O}_{2} + 2 {V}_{o} + 4 {e}^{-} ⇆ 2 {O}_{o} & Equation 7 \\ {C}_{x} {H}_{y} + ( 2 x + y / 2 ) {O}_{2} ⇆ {x CO}_{2} + y / 2 {H}_{2} O + ( 4 x + y ) {e}^{-} & Equation 9\end{matrix}$$

where Vₒ is a doubly charged oxygen anion vacancy and Oₒ is a filled oxygen anion site in the oxygen anion conducting solid state conductor. Pumping oxygen to the electrode surface (the reverse of equation 7) has a beneficial effect in that it allows the combustion reaction to take place in an oxygen depleted process environment.

The sensor is also easy to use and can be used at the POU rather than the POE to provide accurate information about the process environments at all stages of the semiconductor fabrication process.

The total level of contaminants measured by the sensor of the first aspect of the invention provides a semi-quantitative indication of the level of harmful organic contaminants present in the process environment. The non-contaminating light organic molecules present in the process environment do not stick to the surface of the measurement electrode and are not therefore measured. It is only the harmful organic contaminants, which have a high reaction probability with the electrode surface (and therefore with other surfaces encountered in the fabrication process) that undergo dissociation at and are therefore subsequently oxidised at the measurement electrode surface that are detected and therefore monitored by the measurement electrode.

Careful choice of the coating applied to the active measurement electrode or the material from which it is formed will cause some of the harmful organic contaminants to adsorb onto the surface of the active measurement electrode in preference to others. Preferably the active measurement electrode is formed from material whose uptake of organic material proceeds with a sticking probability of or about unity. In addition the organic material is preferably efficiently adsorbed and cracked by the electrode material. Suitable electrode materials include metals selected from the group comprising rhenium, osmium, iridium, ruthenium, rhodium, platinum and palladium and alloys thereof. Alloys of the aforementioned materials with silver, gold and copper may also be used.

The sensor according to the first aspect of the invention is easily and readily manufactured using techniques known to a person skilled in the art. Measurement and reference electrodes, and optionally a counter electrode, can be applied to a thimble of an oxygen anion conductor solid state electrolyte such as ytttria stabilised zirconia either in the form of an ink or a paint or using techniques such as sputtering. The measurement electrodes are isolated from the reference and optional counter electrode via the formation of a gas tight seal. The sensor is suitably supplied with heater means to control the temperature of the electrolyte and means may be provided to monitor the voltage between the measurement electrodes and the reference and counter electrodes respectively.

The reference electrode is suitably formed from a material that is able to catalyse the dissociation of oxygen, for example, platinum. The reference environment can be derived from a gaseous or solid-state source of oxygen. Typically atmospheric air is used as a gaseous reference source of oxygen although other gas compositions can be used. Solid State sources of oxygen typically comprise a metal/metal oxide couple such as Cu/Cu₂O and Pd/PdO or a metal oxide/metal oxide couple such as Cu₂O/CuO. The particular solid-state reference materials chosen will depend on the operating environment of the sensor.

The solid-state electrolyte comprising an oxygen anion conductor is suitably formed from a material, which exhibits oxygen anion conduction at temperatures above 300° C. Suitable oxygen anion conductors include gadolinium doped ceria and yttria stabilised zirconia. Preferred materials for use as the solid-state oxygen anion conductor include 3% and 8% molar yttria stabilised zirconia (YSZ), both of which are commercially available.

A radiative heater may be used to control the temperature of the cell. Such heaters include heating filaments, wound around the solid state electrolyte. An electric light bulb can also be used. A thermocouple may be used to monitor the temperature of the cell.

Currents of between 10 nA/cm² and 100 μA/cm² are suitably used for driving oxygen anions between the reference electrode and the active and inert sensing electrodes. Currents outside this range can be used, depending upon the circumstances. The absolute magnitude of the current used to drive the oxygen anions between the reference and measurement electrodes depends upon the surface area of the electrodes, the partial pressure of oxygen in the sensing environment and the quantities of organic contaminants to be sensed. Larger currents will generally be required for environments that are oxygen free but have high levels of organic contaminants. The sensor is preferably used in conjunction with a device for measuring the potential produced across the cell.

Although the sensor of the first aspect of the invention can be used with just three electrodes (the reference and two measurement electrodes) only, it is preferred to use an electrode arrangement comprising a counter electrode in addition to the measurement and reference electrodes as described above. The counter electrode is positioned adjacent to the reference electrode and in contact with the same reference environment as the reference electrode. In this preferred embodiment, the currents Iₐ and Iᵢ flow between the counter electrode and the active and inert sensing electrodes respectively. The reference electrode therefore provides a constant reference environment from which the electrochemical potentials of both the measurement and counter electrodes and therefore the potential difference across the cell can be determined. The counter electrode is preferably formed from a material such as platinum which actively catalyse the dissociative adsorption of oxygen.

The dimensions of the top and bottom surfaces of the sensor are typically of the order of a few square centimetres or less. The electrodes formed or deposited on each of the surfaces are therefore dimensioned accordingly. The counter electrode is typically equal in surface area to the sum of the measurement electrodes. The reference electrode is usually of a lesser dimension. The electrodes are typically between 0.1 and 50 microns thick.

It will be appreciated that the sensor of the first aspect of the invention can be used to monitor the levels of trace organic contaminants in process environments and another aspect of the invention provides the use of the sensor according to the first aspect of the invention to monitor levels of trace organic contaminants in process environments.

It will further be appreciated that the sensor of the first aspect of the invention can be used in a method for monitoring the level of trace organic contaminants in process environments. A third aspect of the invention provides a method of monitoring the levels of trace organic contaminants in a monitored process environment, the method comprising the steps of providing an electrochemical sensor comprising a solid state oxygen anion conductor in which oxygen anion conduction occurs at or above a critical temperature T_{c}, an active measurement electrode formed on a first surface of the conductor for exposure to the monitored environment, the measurement electrode comprising material for catalysing the oxidation of an organic contaminant molecule to carbon dioxide and water, an inert measurement electrode, formed on the first surface of the conductor adjacent to and independent from the active measurement electrode, for exposure to the monitored environment, the inert measurement electrode comprising material that is catalytically inert to the oxidation of an organic contaminant molecule, and a reference electrode formed on a second surface of the conductor for exposure to a reference environment, the reference electrode comprising material for catalysing the dissociative adsorption of oxygen; raising the temperature of the above the critical temperature T_{c}; passing an electrical current Iₐ between the reference electrode and the active measurement electrode and a electrical current Iᵢ between the reference electrode and the inert measurement electrode, thereby to control the flux of oxygen anions flowing between the reference electrode and the active and inert measurement electrodes respectively; and monitoring the potential difference between the active measurement electrode and the inert electrode, whereby in the absence of organic contaminant molecules the potential difference Vₛₑₙₛₑ between the active and inert measurement electrodes assumes a base value V_{b} and in the presence of organic contaminant molecules the potential difference Vₛₑₙₛₑ between the active and inert measurement electrodes assumes a measurement value Vₘ, the value Vₘ-V_{b} being indicative of the concentration of organic contaminant molecules present in the monitored environment.

As indicated above the use of a sensor having reference, counter and measurement electrodes is preferred to optimise the electrical stability across the cell. Therefore, in a second preferred embodiment of the third aspect of the invention there is provided a sensor having, in addition to the reference and measurement electrode as described above, a counter electrode positioned adjacent to the reference electrode and in contact with the same reference environment as the reference electrode. In this preferred embodiment, the currents Iₐ and Iᵢ flow between the counter electrode and the measurement electrodes. The reference electrode therefore provides a constant reference environment from which the electrochemical potentials of both the measurement and counter electrodes and therefore the potential difference across the cell can be determined.

Preferred features of the present invention will now be described, by way of example only, with reference to the accompanying drawings, in which:

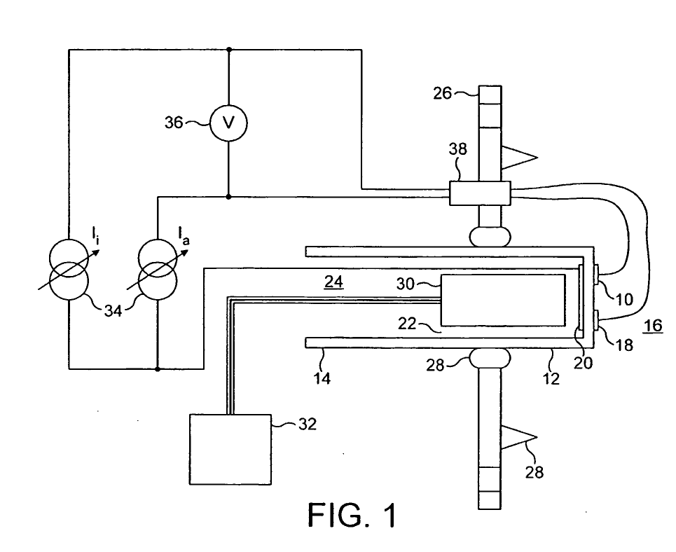

FIG. 1 illustrates a first embodiment of an electrochemical sensor; and

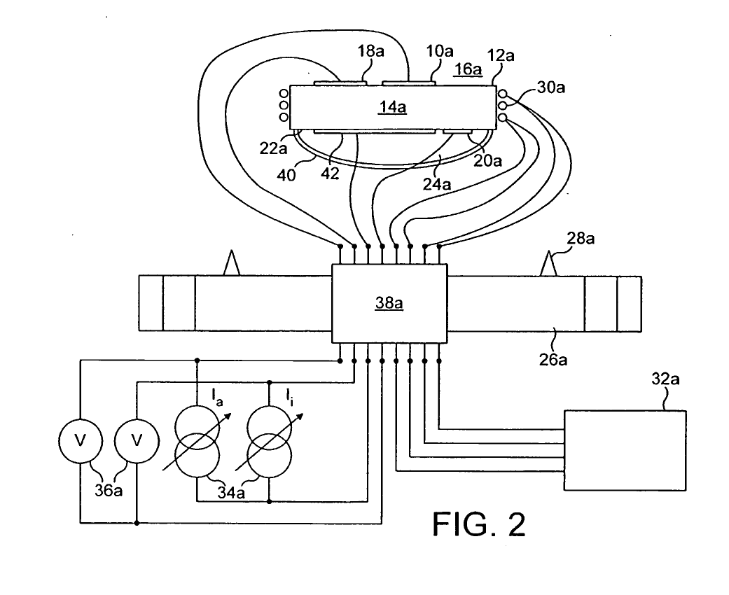

FIG. 2 illustrates a second embodiment of an electrochemical sensor.

The electrochemical sensor of FIG. 1 comprises an active measurement electrode 10 deposited on one side 12 of a solid state electrolyte 14 comprising an 8% yttrium stabilised zirconium oxygen anion conductor. The active measurement electrode 10 may be deposited using a technique such as vacuum sputtering or applying any suitable commercially available “ink” to the surface. In the event that the active measurement electrode 10 is formed on the surface of the electrolyte 14 using ink, the whole assembly must be fired in a suitable atmosphere determined by the nature of the ink. In the preferred embodiment, the active measurement electrode 10 is formed from platinum. Alternatively, the active measurement electrode 10 may be formed from any other material that is able to catalyse the oxidation of an organic contaminant molecule to carbon dioxide and water. In use the active measurement electrode 10 is placed in contact with a monitored environment 16.

An inert measurement electrode 18 is deposited on the same side 12 of the electrolyte 14 as the active measurement electrode 10 using similar techniques to those described above for active measurement electrode 10. In the preferred embodiment the inert measurement electrode 18 is formed from gold. Alternatively, the inert measurement electrode 18 may be formed from any other material that is catalytically inert to the oxidation of an organic contaminant molecule.

A reference electrode 20 is formed on the opposite surface 22 of the electrolyte 14 to the measurement electrodes 10, 18 using similar techniques to those described above for active measurement electrode 10. In the preferred embodiment, the reference electrode 20 is formed from platinum. Alternatively, the reference electrode 20 may be formed from any other material that is able to catalyse the dissociative adsorption of oxygen.

In use, the reference electrode 20 is placed in contact with a reference environment 24, which, in this embodiment, is a gaseous source of oxygen at constant pressure such as atmospheric air. The electrodes 10, 18, 20 and the electrolyte 14 together form an electrochemical cell.

The sensor is mounted in the environment to be monitored using a mounting flange 26, and the measurement electrodes 10, 18 are typically isolated from the reference electrode 20 through the use of gas tight seals 28. In this way it is possible to separate the monitored environment 16 from the reference electrode 20 and the reference environment 24.

The sensor is provided with a heater and thermocouple assembly 30 for heating the sensor and for providing an indication of the temperature of the sensor. The heater and/or thermocouple may be, as illustrated, a self contained cartridge assembly, or may be bonded to the electrolyte prior to the formation of the electrodes; sputtered onto the electrolyte subsequent to the formation of the electrodes or wound round the electrolyte prior to or subsequent to the isolation of the sensing electrodes from the reference and counter electrodes. The temperature of the sensor is controlled by a suitable control device 32.

Constant current sources 34 are provided to control the current Iₐ flowing between the reference electrode 20 and the active measurement electrode 10, and to control the current Iᵢ flowing between the reference electrode 20 and the inert measurement electrode 18. A voltammeter 36 is also provided to measure the potential difference between the active and inert measurement electrodes 10, 18. A gas tight electrical feedthrough 38 permits electrical connections to the constant current sources 34 and the voltammeter to pass into the monitored environment 16.

In use, side 12 of the sensor, and therefore the measurement electrodes 10, 18, is exposed to an environment 16 to be monitored, including any organic contaminants. Organic material is absorbed onto and combusted at the surface of the active measurement electrode 10 due to its reaction with oxygen species pumped to the surface of the active measurement electrode 10 due to current Iₐ. The concentration of oxygen species at the surface of the active measurement electrode 10 is therefore diminished by its reaction with the organic contaminant species present. Since little or no combustion of the organic contaminant occurs at the surface of the inert measurement electrode 18, the electrochemical potential measured at that electrode is a reflection of the concentration of oxygen species present at the surface of that electrode as a result of the application of the current Iᵢ and also the intrinsic (low) concentration of oxygen present in the monitored environment. The measured potential difference between the active and inert measurement electrodes 10, 18 therefore provides an indication of the amount of oxygen consumed by the organic contaminant at the surface of the active measurement electrode and therefore the concentration of organic contaminants in the monitored environment 16.

FIG. 2 illustrates a second embodiment of a sensor, in which the reference numerals refer to the same elements as indicated above, except that the suffix “a” has been added to distinguish the two forms of sensor. In this embodiment, the reference environment 24a is provided by a solid state reference material which is sealed from the sensing environment by sealing material 40, typically a glass material. This embodiment also includes an optional counter electrode 42.

In this embodiment the current generating means 34a passes the constant currents Iₐ, Iᵢ between the counter electrode 42 and the measurement electrodes 10a, 18a so as to minimize errors generated in the voltage measuring device 36a. The voltage measuring device 36a measures the voltage between the active measurement electrode 1oa and the reference electrode 20a, and the voltage between the inert measurement electrode 18a and the reference electrode 20a.

### EXAMPLE

Construction of the Sensor

Reference and measurement electrodes, and optional counter electrode, were formed on a thimble/disc of the oxygen anion conducting electrolyte (commercially available from various suppliers) by sputtering under vacuum or using commercially available ‘inks’ and firing the assembly in a suitable atmosphere according to the procedure given by the ink manufacturer.

A gas tight seal (resistant to both vacuum and pressure) was formed around the oxygen anion conducting electrolyte to isolate the measurement electrodes from the reference electrode and optional counter electrode using standard procedures. Depending upon how the sensor is to be heated the heater/thermocouple can be added at any appropriate stage during manufacture.

The previously described embodiments of the sensor relate to the detection of organic contaminant species in oxygen deficient environments. Under atmospheres containing significant levels of oxygen (partial pressures >2.0 10⁻¹ mbar i.e. >0.1%) as may be found in the exhaust gases from internal combustion engines, for example, oxygen is no longer needed to be pumped to the measurement electrodes to enable the combustion reactions to take place and thereby develop the mixed potential—the oxygen is provided via gas phase adsorption.

However, it is widely known (Vayenas et al, Catalysis Today vol. 11 (1992) pp 303-442) that under such conditions the catalytic properties of electrodes can be modified by pumping quantities of oxygen to the surface of the electrodes, currents typically in the range 1 microamp/cm²−1 milliamp/cm². This Non Faradaic Electrochemical Modification of Chemical Activity is known as the NEMCA effect. Here the oxygen anions pumped to the surface of the electrodes do not take place in the combustion reactions directly but rather act as promoters for the heterogeneous combustion of the organic contaminant species by gas phase oxygen. Thus, by controlling the quantities of promoting oxygen anions at the surface, via the currents Iₐ and Iᵢ, different rates of combustion will occur giving rise to different mixed potentials at the electrodes. This is in contrast to the method in DE95/00255 where the dissimilar catalytic reactions and hence the mixed potentials are enhanced by operating the electrodes at different temperatures which is difficult to achieve practically.

The activation of the NEMCA effect increases the rate of combustion of organic contaminant at the surface of the active measurement electrode and therefore reduces the overall response time and increases the sensitivity of the sensor.

In all cases the potential difference between the active and inert measurement electrodes will depend upon the positions of the mixed potential present on the electrode surfaces. The mixed potential, for a particular electrode surface, arises from the catalytic competition between the electrochemical reduction of oxygen and the oxidation or combustion of the organic material arriving at the electrode surface.

$$\begin{matrix}{O}_{2} + 2 {V}_{o} + 4 {e}^{-} ⇆ 2 {O}_{o} & Equation 7 \\ {C}_{x} {H}_{y} + ( 2 x + y / 2 ) {O}_{2} ⇆ {x CO}_{2} + y / 2 {H}_{2} O + ( 4 x + y ) {e}^{-} & Equation 9\end{matrix}$$

where Vₒ is a doubly charged oxygen anion vacancy and Oₒ is a filled oxygen anion site in the oxygen anion conducting solid state conductor. Pumping oxygen to the electrode surface (the reverse of equation 7) has a number of beneficial effects:

Firstly it increases the rate of the combustion reactions occurring at the electrode surface by virtue of the NEMCA effect. Catalytic reaction rates can be enhanced by a factor of up to 1000. This results in a faster and potentially bigger sensor response.

Secondly, by pumping different amounts of oxygen to the electrodes the NEMCA effect can be controlled and different mixed potentials can be achieved on electrodes of the same material type.

The sensor construction for operation at high oxygen levels is identical to that for use in oxygen deficient environments save that solid state reference materials cannot be use due to the potentially high oxygen anion currents—the solid state reference material would become exhausted in a short period of time.

In use the sensor operates by passing an anion current, Iₐ (O²⁻), between the reference electrode and one of the measurement electrodes to maintain the potential difference between the sensing and reference electrodes at a fixed value, Vₐ. Depending upon the electrode configuration, three possible sensing modes are possible:

Firstly the active and inert measurement electrodes may be formed from catalytically dissimilar materials. The active measurement electrode may, for example, be formed from platinum and the inert measurement electrode from gold. In use the current, Iᵢ, flowing between the reference electrode and the inert measurement electrode mirrors that between the reference electrode and the active measurement electrode, la, and the potential difference between the two measurement electrodes is measured.

Secondly the current Iᵢ may be a sub-unit multiple of or equal to the current, Iₐ, and the potential difference between the two measurement electrodes is again measured.

Finally, the active and inert measurement electrodes may be formed from catalytically similar materials, such as platinum, for example. In this case the current flowing between the reference and inert measurement electrodes is a sub-unit multiple of the current flowing between the reference and active measurement electrodes and the potential difference between the two sensing electrodes is again measured.

For operation in atmospheres containing significant levels of oxygen (partial pressures >2.0 10⁻¹ mbar i.e. >0.1%) the third electrode configuration listed above will be preferred—for operation in oxygen deficient environments the first electrode configuration is preferred.

1. An organic contaminant molecule sensor for use in a low oxygen concentration monitored environment:
an electrochemical cell comprising:
a solid state oxygen anion conductor in which oxygen anion conduction occurs at or above a critical temperature T_{c};
an active measurement electrode formed on a first surface of the conductor for exposure to the monitored environment, the measurement electrode comprising material for catalyzing the oxidation of an organic contaminant molecule to carbon dioxide and water;
an inert measurement electrode formed on the first surface of the conductor adjacent to and independent from the active measurement electrode for exposure to the monitored environment, the inert measurement electrode comprising material that is catalytically inert to the oxidation of an organic contaminant molecule; and
a reference electrode formed on a second surface of the conductor for exposure to a reference environment, the reference electrode comprising material for catalyzing the dissociative adsorption of oxygen;
means for controlling and monitoring the temperature of the cell;
means for controlling the electrical current Iₐ flowing between the reference electrode and the active measurement electrode and the electrical current Iᵢ flowing between the reference electrode and the inert measurement electrode to control the flux of oxygen anions flowing between the reference electrode and the active and inert measurement electrodes respectively; and means for monitoring the potential difference between the active measurement electrode and the inert electrode, wherein in the absence of organic contaminant molecules the potential difference Vₛₑₙₛₑ between the active and Inert measurement electrodes assumes a base value V_{b} and in the presence of organic contaminant molecules the potential difference Vₛₑₙₛₑ between the active and inert measurement electrodes assumes a measurement value Vₘ, the value Vₘ-V_{b} being indicative of the concentration of organic contaminant molecules present in the monitored environment.

2. The sensor according to claim 1 wherein the active measurement electrode is coated with or formed from a metal selected from the group of metals consisting of rhenium, osmium, iridium, ruthenium, rhodium, platinum, palladium and alloys thereof.

3. The sensor according to claim 2 wherein the alloys include one or more elements selected from the group of elements consisting of silver, gold and copper.

4. The sensor according to claim 1 wherein the reference electrode is formed from a material able to catalyze the dissociation of oxygen.

5. The sensor according to claim 4 wherein the reference electrode is formed from platinum, palladium or other metal able to dissociatively adsorb oxygen or any alloy thereof.

6. The sensor according to claim 1 wherein the solid state oxygen anion conductor comprises a compound selected from the group of compounds consisting of gadolinium doped ceria and yttria stabilized zirconia.

7. The sensor according to claim 1 comprising a counter electrode positioned adjacent to the reference electrode.

8. The sensor according to claim 7 wherein the counter electrode is formed from platinum, palladium or other metal able to dissociatively adsorb oxygen.

9. The sensor according to claim 1 wherein the reference environment is a gaseous source of oxygen.

10. The sensor according to claims 1 wherein the reference environment comprises a solid-state source of oxygen.

11. The sensor according to claim 10 wherein the solid state source comprises a metal-/-metal oxide couple (optionally Cu/Cu₂O or Pd/PdO) or a metal oxide-/metal oxide couple (optionally Cu₂O/CuO).

12. The sensor according to claim 1 wherein the means for controlling or monitoring the temperature of the cell comprises a heater and thermocouple arrangement.

13. Use of a sensor according to claim 1 for monitoring the levels of trace organic contaminants in a low oxygen concentration monitored process environment.

14. A method of monitoring the levels of trace organic contaminants in a monitored process environment, the method comprising the steps of:
providing an electrochemical sensor comprising:
a solid state oxygen anion conductor in which oxygen anion conduction occurs at or above a critical temperature T_{c};
an active measurement electrode formed on a first surface of the conductor for exposure to the monitored environment, the measurement electrode comprising material for catalyzing the oxidation of an organic contaminant molecule to carbon dioxide and water;
an inert measurement electrode formed on the first surface of the conductor adjacent to and independent from the active measurement electrode for exposure to the monitored environment, the inert measurement electrode comprising material that is catalytically inert to the oxidation of an organic contaminant molecule; and
a reference electrode formed on a second surface of the conductor for exposure to a reference environment, the reference electrode comprising material for catalyzing the dissociative adsorption of oxygen;
raising the temperature of the cell above the critical temperature T_{c};
passing an electrical current Iₐ between the reference electrode and the active measurement electrode and a electrical current Iᵢ between the reference electrode and the inert measurement electrode to control the flux of oxygen anions flowing between the reference electrode and the active and inert measurement electrodes respectively; and
monitoring the potential difference between the active measurement electrode and the inert electrode so that in the absence of organic contaminant molecules the potential difference Vₛₑₙₛₑ between the active and inert measurement electrodes assumes a base value V_{b} and in the presence of organic contaminant molecules the potential difference Vₛₑₙₛₑ between the active and inert measurement electrodes assumes a measurement value Vₘ, the value Vₘ-V_{b} being indicative of the concentration of organic contaminant molecules present in the monitored environment.

15. The method according to claim 14 wherein Iₐ is in the range from 10 nA to 100 μA.

16. The method according to claim 14 wherein the sensor is provided with a counter electrode adjacent the reference electrode.

17. The method according to any of claims 14 the reference environment is a gaseous source of oxygen at atmospheric pressure, preferably atmospheric air.

18. The method according to claim 14, wherein the reference environment comprises a solid-state source of oxygen.

19. The method according to claim 18 wherein the solid state source comprises a metal-/-metal oxide couple (optionally Cu/Cu₂O or Pd/PdO), or a metal oxide-/metal oxide couple (optionally Cu₂O/CuO).

20. An organic contaminant molecule sensor for use in a low oxygen concentration monitored environment comprising:
an electrochemical cell comprising:
an oxygen anion conductor in which oxygen anion conduction occurs at or above a critical temperature T_{c};
an active measurement electrode in contact with the conductor for exposure to the monitored environment, the measurement electrode comprising material for catalyzing the oxidation of an organic contaminant molecule to carbon dioxide and waters;
an inert measurement electrode in contact with the conductor independent from the active measurement electrode for exposure to the monitored environment, the inert measurement electrode comprising material that is catalytically inert to the oxidation of an organic contaminant molecule; and
a reference electrode in contact with the conductor for exposure to a reference environment, the reference electrode comprising material for catalyzing the dissociative adsorption of oxygen;
means for controlling and monitoring the temperature of the cell;
means for controlling the electrical current Iₐ flowing between the reference electrode and the active measurement electrode and the electrical current Iᵢ flowing between the reference electrode and the inert measurement electrode to control the flux of oxygen anions flowing between the reference electrode and the active and inert measurement electrodes respectively such that the NEMCA effect is activated; and
means for monitoring the potential difference between the active measurement electrode and the inert electrode, so that in the absence of organic contaminant molecules the potential difference Vₛₑₙₛₑ between the active and inert measurement electrodes assumes a base value V_{b} and in the presence of organic contaminant molecules the potential difference Vₛₑₙₛₑ between the active and inert measurement electrodes assumes a measurement value Vₘ, the value Vₘ-V_{b} being indicative of the concentration of organic contaminant molecules present in the monitored environment.
